(19) United States
(12) Patent Application Publication
(10) Pub. No.: US 2026/0057735 A1
(43) Pub. Date: Feb. 26, 2026

(54) GAMING ESTABLISHMENT DEVICE MODIFICATION BASED ON TRACKED RISK OF DISENGAGEMENT

(71) Applicant: IGT, Las Vegas, NV (US)

(72) Inventors: Kevin Higgins, Reno, NV (US); Dwayne Nelson, Las Vegas, NV (US)

(21) Appl. No.: 18/812,516

(22) Filed: Aug. 22, 2024

(51) Int. Cl. G07F 17/32

(52) U.S. Cl. CPC G07F 17/3234; G07F 17/3227

(57) ABSTRACT

Systems and methods that determine a level of risk associated with a user's interactions with a gaming establishment device and, in certain instances based on the determined level of risk, modify an operation of the gaming establishment device and/or offer the user zero, one or more benefits.

### BACKGROUND

In various embodiments, the systems and methods of the present disclosure determine a level of risk associated with a user's interactions with a gaming establishment device and, in certain instances based on the determined level of risk, modify an operation of the gaming establishment device and/or offer the user zero, one or more benefits.

Gaming machines may provide players awards in primary games. Gaming machines generally require the player to place a wager of cashable credits to activate the primary game. The award of cashable credits may be based on the player obtaining a winning symbol or symbol combination and on the amount of the wager.

### BRIEF DESCRIPTION OF SEVERAL VIEWS OF THE DRAWINGS

FIG. 1A is a flow chart of an example process for operating a system which monitors a user's engagement with a gaming establishment device to determine a risk of disengagement and determines zero, one or more intervention actions to mitigate any determined risk of disengagement.

FIG. 1B is a flow chart of an example process for operating a system which monitors a user's engagement with a gaming establishment device to determine a risk of disengagement and at least partially employs the assistance of gaming establishment personnel to determine zero, one or more intervention actions to mitigate any determined risk of disengagement.

FIG. 2A is a flow chart of an example process for operating a system which modifies an operation of a gaming establishment device responsive to a determination that activity at the gaming establishment device is associated with a certain risk of disengagement.

FIG. 2B is a flow chart of an example process for operating a system which operates with a mobile device of a user to switch to another gaming establishment device responsive to a determination that activity at a current gaming establishment device is associated with a certain risk of disengagement.

FIG. 2C is a flow chart of an example process for operating a system which operates with a mobile device of a user to offer an incentive to the user to switch to another gaming establishment device responsive to a determination that activity at a current gaming establishment device is associated with a certain risk of disengagement.

FIG. 2D is a flow chart of an example process for operating a system which operates with a gaming establishment personnel mobile device to determine different intervention actions based on one or more factors contributing to a determined risk of disengagement of a user at a gaming establishment device.

FIG. 3A is a screenshot of a display device of an example gaming establishment device illustrating the system recommending an operational change of the gaming establishment device responsive to a determination that activity at the gaming establishment device is associated with a certain risk of disengagement.

FIG. 3B is a screenshot of a display device of an example gaming establishment personnel mobile device illustrating the system interacting with the gaming establishment personnel to determine any risk of disengagement of a user at a gaming establishment device.

FIG. 4 is a schematic block diagram of one embodiment of an electronic configuration of an example electronic gaming machine of the present disclosure.

FIGS. 5A and 5B are perspective views of example alternative embodiments of electronic gaming machines of the present disclosure.

FIG. 5C is a front view of an example personal gaming device of the present disclosure.

### DETAILED DESCRIPTION

In various embodiments, the systems and methods of the present disclosure determine a level of risk associated with a user's interactions with a gaming establishment device and, in certain instances based on the determined level of risk, modify an operation of the gaming establishment device and/or offer the user zero, one or more benefits.

In certain embodiments, the system monitors one or more aspects of a user's engagement with a gaming establishment device, such as monitoring a user's interactions with an electronic gaming machine (“EGM”). In these embodiments, the system tracks one or more events and/or activities occurring in association with the gaming establishment device (e.g., tracks losing plays of games at an EGM), tracks relative occurrences of events and/or activities occurring in association with the gaming establishment device (e.g., tracks a frequency of wagers placed at an EGM over different periods of time) and/or tracks events and/or activities associated with the user of the gaming establishment device (e.g., tracks instances when a player of an EGM looks away during a play of a game at the EGM). Such tracking enables the system to determine whether or not the user's engagement with the gaming establishment device represents a heightened risk of disengagement. That is, by monitoring various factors such as, but not limited to, gaming establishment device factors (e.g., amount of time of a gaming session, wins/losses of one or more gaming sessions, actual wins/losses of one or more gaming sessions relative to theoretical wins/losses for such gaming sessions, changes to frequency of games played over a gaming session, changes to wager amounts placed over a gaming session, and/or quantities of winning/losing games in a row), and/or user factors (e.g., a user taking certain actions/not taking certain actions indicative of the user being bored, intoxicated, lonely or otherwise satisfied/dissatisfied with their experience at the gaming establishment device), the system determines a relative risk that the user will disengage from interacting with the gaming establishment device (and potentially leave the gaming establishment) having had a negative experience (e.g., being in a relatively undesirable mood, such as angry, tired and/or frustrated) at the gaming establishment device.

In certain embodiments, in addition to monitoring one or more aspects of a user's engagement with a gaming establishment device, the system determines, based on such monitored aspects whether any intervention actions are warranted. In these embodiments, since the tracking of different events and/or activities associated with a user's interactions with (or lack of interactions with) the gaming establishment device enables the system to determine whether or not the user's engagement with the gaming establishment device represents a heightened risk of disengagement, the system determines if such a potential risk exists and if so, determines if the potential risk can possibly be remedied by one or more intervention actions initiated by the system.

In certain embodiments, if the system determines that an intervention action is warranted, the system determines the intervention action to undertake. In these embodiments, since different situations that arise in association with a user's engagement with a gaming establishment device require different solutions and further since similar situations that arise in association with different users'engagements with different gaming establishment devices require different solutions, the system operates to employ a custom solution to the particular circumstances that led to the determination that one or more intervention events are warranted. For example, while a first player at a first EGM that has lost at least a threshold quantity of games in a row and a second player at a second EGM that is exhibiting signs of boredom by frequently looking at their mobile device during plays of games both pose a potential risk of disengagement, the system determines different intervention actions tailored to the different situations that the first player and the second player find themselves in.

In certain embodiments, the intervention action determined by the system includes an operational change of the gaming establishment device. In certain such embodiments, the operational change of the gaming establishment device includes a change of (or at least an offered change of) a game of the gaming establishment device (e.g., an EGM changes from one game theme to another game theme). In certain such embodiments, the operational change of the gaming establishment device includes a change of (or at least an offered change of) a parameter of the gaming establishment device (e.g., an EGM changes a denomination available to be placed).

In certain embodiments, the intervention action determined by the system includes the system providing a benefit to the user and/or another user. In certain such embodiments, the benefit is associated with a user's continued engagement with the gaming establishment device (e.g., double player tracking points earned for continuing with a gaming session at an EGM) and/or associated with a user's engagement with another gaming establishment device (e.g., a free play of a game at another EGM). In certain such embodiments, the benefit is independent of a user's engagement of any gaming establishment device (e.g., complimentary tickets to a gaming establishment show for the user and the user's companion).

In certain embodiments, the intervention action determined by the system includes gaming establishment personnel intervention. In certain such embodiments, the system dispatches one or more members of gaming establishment personnel to the gaming establishment device to interact with the user and provide zero, one or more benefits to the user and/or another user (e.g., gaming establishment personnel offers a coupon for a free coffee to a player at an EGM determined by the system to be tired). In certain such embodiments, the system dispatches one or more members of gaming establishment personnel to the gaming establishment device to interact with the user to assess the situation and then, if applicable, take one or more actions to remedy the situation assessed by the member of gaming establishment personnel (e.g., gaming establishment personnel determine that a player at an EGM has demonstrated the attributes of a distracted player because the area of the EGM is too crowded so the gaming establishment personnel assists the player in moving to another location where the same EGM is available to be played).

Such a configuration of undertaking (or offering to undertake) zero, one or more intervention actions responsive to a determination that a user at a gaming establishment device represents an increased risk of disengagement (from the gaming establishment device and/or the gaming establishment in general) represents an operational change to how gaming establishment systems operate for the betterment of both users (via a more positive (or less negative) gaming establishment experience) and gaming establishment operators (via combating certain factors that would diminish user's future engagement with the gaming establishment device). Such a configuration further enables different users to have different customizable interactions at a gaming establishment while automating and improving the efficacy of certain tasks (by reducing or eliminating gaming establishment personnel having to make, at best, educated guesses in trying to determine why certain users take/don't take certain actions). As such, gaming establishment operators are able to allocate user retention resources more efficiently and thus reduce wasted resources, such as wasted computational resources associated with offering users benefits that they have no interest in and/or at the wrong time and/or responsive to wrong behavioral triggers.

In various embodiments, a system of the present disclosure includes (or is otherwise in communication with) various components or sub-systems operating individually or together to offer zero, one or more intervention actions in association with one or more monitored aspects of a user's engagement with a gaming establishment device. In certain embodiments, the system includes one or more user engagement retention components, such as one or more servers which receive data indicative of a user's engagement with a gaming establishment device and/or determine any intervention action based on an assessment of the user's engagement. In certain embodiments, the system is in communication with a distinct and independently operating user engagement retention component, such as one or more servers which receive data indicative of a user's engagement with a gaming establishment device and/or determine any intervention action based on an assessment of the user's engagement. In these different embodiments, the user engagement retention component operates with one or more gaming establishment devices and zero, one or more other gaming establishment components, such as one or more servers of a patron management system and/or one or more servers of a gaming establishment personnel management system, to determine a level of risk associated with a user's interactions with a gaming establishment device and, in certain instances based on the determined level of risk, determine zero, one or more intervention actions (that may or may not involve such other gaming establishment components) to potentially mitigate the determined risk.

In certain embodiments, one or more gaming establishment devices operate directly with one or more user engagement retention components to enable zero, one or more intervention actions based on an assessment of a user's engagement with the gaming establishment device. In certain embodiments, one or more gaming establishment devices operate indirectly with one or more user engagement retention components to enable zero, one or more intervention actions based on an assessment of a user's engagement with the gaming establishment device. For example, a component a gaming establishment patron management system, such as a slot machine interface board (“SMIB”), may be in communication with an EGM, which operates, individually or in conjunction with a user engagement retention component to track activities occurring in association with the EGM and determine, based on an assessment of the tracked activities, whether or not any intervention actions are warranted. In another example, a component a gaming establishment device management system, such as a gaming table host operable to manage a plurality of gaming tables, may be in communication with one or more electronic gaming tables (and/or electronic table game terminals) which operate, individually or in conjunction with a user engagement retention component to track activities occurring in association with such gaming table(s) (and/or such electronic table game terminals) and determine, based on an assessment of the tracked activities, whether or not any intervention actions are warranted.

In operation of certain embodiments, the gaming establishment devices (and/or one or more components of one or more gaming establishment management systems (e.g., components of the gaming establishment patron management system and/or of the gaming establishment device management system)) notify one or more components of a user engagement retention system of zero, one or more activities undertaken at such gaming establishment devices. The component of the user engagement retention system then operates to determine, based on an assessment of the tracked activities, whether or not any intervention actions should be undertaken. In other words, upon an occurrence of an intervention action determination event, the system determines zero, one or more courses of action to potentially modify how the user is engaging with a gaming establishment device. Following such a determination of zero, one or more courses of action and upon an occurrence of an intervention action realization event, the system undertakes such determined actions with an aim of modifying how the user is engaging with the gaming establishment device. Accordingly, in various embodiments, the system utilizes a user engagement retention component to track certain activities occurring at certain gaming establishment devices and, if the need arises based on an evaluation of the tracked activities, takes one or more actions to alter the user's engagement. This utilization of a user engagement retention component not only reduces the computation load of existing gaming establishment components in determining how to interact with a user, but also enables gaming establishment operators to employ, based on real time data, centralized customer management determinations.

It should be appreciated that while described, in certain instances, in relation to the system quantifying a user's experience at a gaming device of a gaming establishment and modifying zero, one or more operational aspects responsive to a determination that the user at the gaming device poses a certain risk of disengagement, the system of the present disclosure may, in certain instances, quantify a user's experience at a non-gaming device at (or otherwise associated with) a gaming establishment and modifying zero, one or more operational aspects responsive to a determination that the user at the non-gaming device poses a risk of disengagement. Such non-gaming devices include, but are not limited to, one or more kiosks, one or more retail point-of-sale terminals, one or more ticket voucher redemption kiosks or any other device operable to interact with a gaming establishment patron. Such gaming devices include any suitable EGM (such as, but not limited to: a slot machine, a video poker machine, a video blackjack machine, a video baccarat machine, a video keno machine, a video bingo machine, a video lottery terminal), any suitable sporting wagering terminal, any suitable terminal associated with a table game being played at a remote electronic gaming table, any suitable user station of an electronic gaming table at which a table game may be played, any suitable terminal associated with a table game being played at a remote non-electronic gaming table, any suitable user station of a non-electronic gaming table at which a table game may be played, any suitable personal gaming device (e.g., a user's mobile device accessing an online gaming establishment and/or executing a mobile device application associated with the gaming establishment), and/or any other device operable to enable a user to participate in a trackable activity, such as one or more of place a wager on a play of a game of chance, place a wager on a play of a game of skill, place a wager on a play of a table game and place a wager on an outcome of a sporting event.

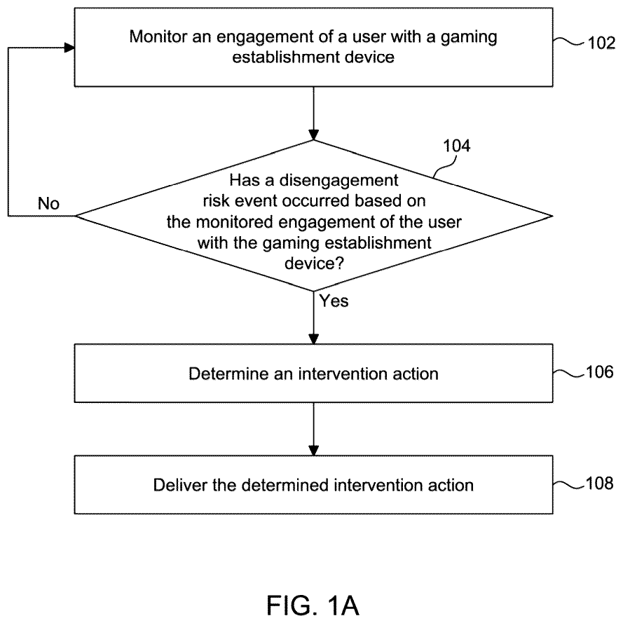

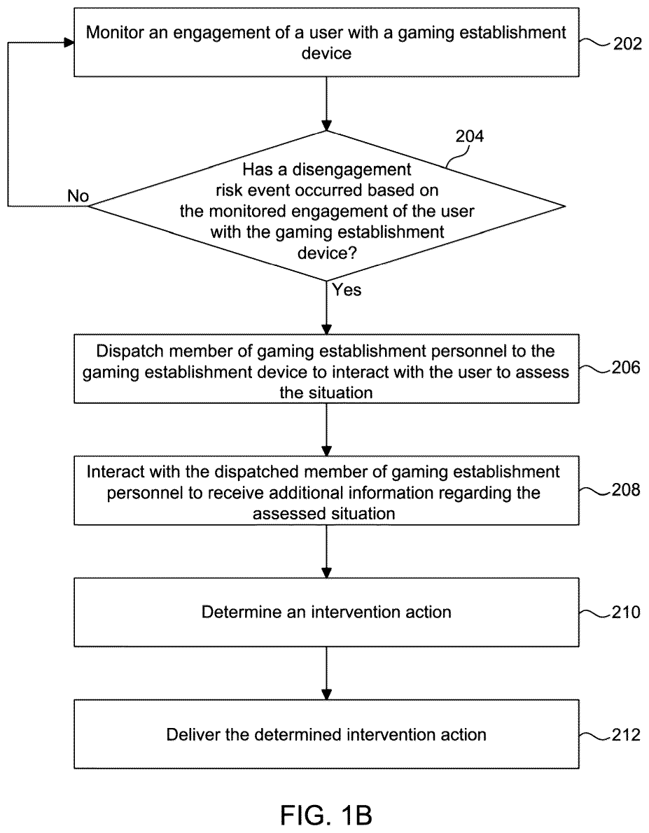

In certain embodiments, following a user engaging a gaming establishment device, such as depositing funds on the gaming establishment device and/or making one or more inputs received by the gaming establishment device, the system monitors an engagement of a user with a gaming establishment device as indicated in block 102 of FIG. 1A. In certain such embodiments, the system monitors the user's engagement (or disengagement) by tracking one or more events and/or activities occurring in association with the gaming establishment device. That is, to enable the system to quantify one or more emotions potentially experienced by the user (e.g., angry, tired or frustrated) that are associated with an increased risk of the user terminating their engagement with the gaming establishment device (or the gaming establishment in general), the system tracks certain activities and/or events the occurrence of which (or the lack of occurrence of which) may factor into the user's decision to continue (or discontinue) their gaming establishment device engagement.

In certain embodiments, the system tracks wagering activities of a user in association with one or more wagering sessions at a gaming device, such as tracking wagers placed at an EGM and/or time spent placing wagers at an EGM. In certain embodiments, the system tracks one or more events occurring in association with one or more wagering sessions of a user at a gaming device, such as tracking symbol combinations generated at an EGM. In certain embodiments, the system tracks non-wagering activities of a user occurring in association with one or more wagering sessions at a gaming device, such as tracking deposits of funds at an EGM and/or tracking alcoholic beverages ordered to the EGM. In certain embodiments, the system tracks activities of a user and/or events occurring in association with one or more non-gaming devices, such as tracking purchasing activities occurring in association with a point-of-sale terminal of a gaming establishment retail system.

In certain embodiments, the tracking occurs in association with identified users such that following a user identifying themselves at a gaming establishment device, the system tracks one or more events and/or activities occurring in association with that identified user's engagement of the gaming establishment device. In certain such embodiments, to track activities and/or events in association with a user, the system identifies the user at a gaming establishment device following the user presenting an identifier, such as a player tracking card, at the gaming establishment device. In certain embodiments, to tracked activities and/or events in association with a user, the system identifies the user at a gaming establishment device following the user pairing a mobile device with the gaming establishment device (or with a component of a gaming establishment management system, such as with a SMIB associated with an EGM). In such embodiments, following the presentation of an identifier or a pairing of a mobile device, the gaming establishment device, the component of the gaming establishment management system and/or the system (e.g., a component of the user engagement retention system associated with the gaming establishment device) tracks certain activities and/or events occurring in association with the gaming establishment device which may lead to modifying zero, one or more aspects of the user's engagement. Tracking activities and/or events occurring in association with identified users enables the system to track such activities and/or events across multiple gaming establishment devices in association with the same user. In certain embodiments, the tracking occurs independent of whether or not the user is an identified user such that with or without a user identifying themselves at a gaming establishment device, the system tracks one or more events and/or activities occurring in association with the user's engagement of the gaming establishment device. Tracking activities and/or events occurring in association with anonymous users limits the system to track activities and/or events for the anonymous user in association with a single gaming establishment device where the activity and/or event occurred.

In certain embodiments, the tracked activities and/or events include one or more events which occur in association with one or more plays of one or more games at a gaming device, such as an EGM. In different embodiments, the tracked events include any singular event and/or any sequence or series of events, such as, but not limited to: a placement of a wager (regardless of the wager amount); a placement of a side-wager (regardless of the side-wager amount); a placement of a wager on a number of paylines; a placement of a wager on a designated payline; a placement of a wager on a number of ways to win; a speed of play by a user; a change in a speed of play by a user; a betting pattern by a player; a change in betting pattern by a user; a change in a type of game played; an amount won; an amount lost; a quantity of games played; a quantity of games won; a quantity of games lost; an amount of a theoretical win; an amount of a theoretical hold; an activation of a reel; a stopping of a reel, an activation of a plurality of reels; a stopping of a plurality of reels, a generation of any outcome (or a designated outcome); a generation of any outcome (or a designated outcome) associated with an award; a generation of any outcome (or a designated outcome) associated with an award over a designated value; a generation of an outcome on a designated payline; a generation of an outcome in a scatter configuration; a generation of a winning way to win; a generation of a designated symbol or symbol combination; a generation of a designated symbol or symbol combination on a designated payline; a generation of a designated symbol or symbol combination in a scatter configuration; a payment of an award amount; a triggering of a play of a secondary game; an activation of a secondary display; an activation of a community award generator; and/or a generation of any outcome (or a designated outcome) in a secondary game. In these embodiments, the system employs the occurrences (or lack thereof) of one or more of such tracked events to assess a prediction of the user's decision to continue (or discontinue) their gaming establishment device engagement.

In certain embodiments, the tracked activities additionally or alternatively include one or more actions taken, such as via zero, one or more inputs, which occur after one or more events occurring in one or more plays of one or more games at a gaming device. For example, the tracked activities include which inputs are made by a user responsive to which images are displayed to the user as well as the timing of such inputs. In another example, the tracked activities include a selection of one or more bonus games to play following a bonus game triggering event as well as any selections made by the user during the bonus games, the timing of such selections and the results of the bonus games.

In certain embodiments, the tracked events include one or more events which occur independent of any plays of any games at a gaming establishment device. For example, the tracked activities include what non-gaming content was displayed to the user via a service window and when such content was displayed. In another example, the system tracks one or more aspects of a user's biometric data, such as a user's monitored heartrate, a user's temperature, audio data associated with a user (e.g., a user's voice), captured body motions and/or captured facial expressions. In certain embodiments, the tracked activities additionally or alternatively include one or more actions taken, such as via zero, one or more inputs, which occur after one or more events which occur independent of any plays of any games at the gaming establishment device. For example, the tracked activities include which inputs are made by a user responsive to which non-gaming images are displayed to the user via a service window as well as the timing of such inputs.

It should be appreciated that any suitable event which occurs in association with a user's interaction with a gaming establishment device and/or any suitable quantifiable action the user takes (or does not take) in association with the user's interaction with the gaming establishment device may be tracked and employed in associated with the determination of a level of risk of the user disengaging from the gaming establishment device. That is, data associated with any trackable input at a gaming establishment device (and/or via a paired mobile device) and/or any trackable output from the gaming establishment device (and/or via a paired mobile device) which occurs in association with one or more plays of one or more games played at the gaming establishment device, or occurs independent of any games played at the gaming establishment device may be tracked in accordance with the system of the present disclosure. As such, any suitable event, series of events or lack of an event may qualify as an occurrence of a trackable event utilized to quantify a user's engagement at a gaming establishment device to determine whether any intervention actions are warranted.

In certain embodiments, the system utilizes the gaming establishment device to track certain data associated with the user's engagement of the gaming establishment device. In certain embodiments, the system utilizes a component of the gaming establishment device to track certain data associated with the user's engagement of the gaming establishment device. For example, the system employs a camera of an EGM to capture video of the user's engagement with the EGM to determine where the user is looking while playing one or more games and/or any facial expressions made by the user. In another example, the system employs a microphone of an EGM to capture sound data of the user's engagement with the EGM to determine if the user is making any sounds indicative of a positive (or negative) experience at the EGM. In certain embodiments, the system utilizes a component independent of the gaming establishment device to track certain data associated with the user's engagement of the gaming establishment device. For example, the system employs one or more security cameras of a gaming establishment and/or cameras of a paired mobile device to determine if the user is taking any physical actions indicative of a positive (or negative) experience at the EGM.

In certain embodiments, the system tracks the same metric, if applicable, for each gaming establishment device. In certain embodiment, the system tracks different metrics for different gaming establishment devices such that the tracked events vary by the gaming establishment device employed. In certain embodiments, the system tracks the same metric, if applicable, for different types of activities occurring in association with one or more gaming establishment devices. In certain embodiment, the system tracks different metrics for different types of activities occurring in association with one or more gaming establishment devices such that the tracked events vary by the activities employed. In certain embodiments, the system tracks the same metric, if applicable, for each user. In certain embodiment, the system tracks different metrics for different users such that the tracked events vary by the user.

In certain embodiments, in addition monitoring a user's engagement with a gaming establishment device, the system determines whether zero, one or more monitored aspects of the user's engagement result in an occurrence of a disengagement risk event as indicated in block 104 of FIG. 1A. In certain such embodiments, the system utilizes part or all of the tracked activities and/or events to determine if the user is at an elevated risk of terminating their engagement with the gaming establishment device based on such tracked activities and/or events. In these embodiments, the system utilizes one or more attributes of the user's tracked engagement with (and/or independent of) the gaming establishment device to determine whether or not such tracked engagement represents a risk of disengagement that exceeds a threshold risk of disengagement. That is, the tracking of various aspects of a user's engagement (or lack thereof) with a gaming establishment device enables the system to determine whether or not the user's engagement (or lack thereof) with the gaming establishment device may result in the user terminating such an engagement with the gaming establishment device (and/or the gaming establishment more generally). As such, by monitoring various factors associated with a gaming establishment device (e.g., amount of time of a gaming session, wins/losses of the gaming session, changes to frequency of games played over a gaming session, changes to wager amounts placed over a gaming session, quantities of winning/losing games in a row), and/or associated with a user (e.g., a user taking certain actions/not taking certain actions indicative of the user being bored, intoxicated, lonely or otherwise satisfied/dissatisfied with their experience at the gaming establishment device), the system determines a relative risk that the user will disengage the gaming establishment device (and potentially leave the gaming establishment) having had a negative experience (e.g., being in a relatively undesirable mood, such as angry, tired and/or frustrated) at the gaming establishment device.

In certain embodiments, the system employs historical data of the user to determine if one or more actions (or inactions) of the user are indicative of a potential risk of disengagement. For example, if historical data associated with the user provides that after five losing hands in a row, the user is more likely to terminate a gaming session, the system utilizes such historical data to determine if a potential risk of disengagement occurs following the system tracking five losing hands in a row during a current gaming session. In certain embodiments, the system employs historical data of similar users to determine if one or more actions (or inactions) of the user are indicative of a potential risk of disengagement. For example, if historical data associated with a category of user which the identified user belongs in provides that increasing the speed by which such users engage the wager button of an EGM is indicative of such users being more likely to terminate a gaming session at the EGM, the system utilizes such historical data to determine if a potential risk of disengagement occurs following the system determining, based on the tracked data, that a user has recently increased the frequency by which the user engages the wager button of the EGM. In certain embodiments, the system employs historical data of all users to determine if one or more actions (or inactions) of the user are indicative of a potential risk of disengagement. For example, if historical data of all users provides that looking at their mobile devices more than twenty times over a five minute span is indicative of such users being more likely to terminate a gaming session, the system utilizes such historical data to determine if a potential risk of disengagement occurs following the system determining that a user has recently increased the amount of time looking at their mobile device.

In certain embodiments, the system employs historical data associated with the gaming establishment device to determine if one or more actions (or inactions) of the user are indicative of a potential risk of disengagement. In certain embodiments, the system employs historical data of similar gaming establishment devices (e.g., EGMs offering the same game, EGMs offering the type of game) to determine if one or more actions (or inactions) of the user are indicative of a potential risk of disengagement. In certain embodiments, the system employs historical data of all gaming establishment devices to determine if one or more actions (or inactions) of the user are indicative of a potential risk of disengagement.

In certain embodiments, the system employs one or more artificial intelligence learning models (which are provided part or all of the tracked data from some or all of the gaming establishment devices) to determine which aspects of user's interactions with one or more gaming establishment devices quantify as negative interactions that may result in a premature disengagement from the gaming establishment device. For example, if the system monitors that game play at an EGM is slowing down, the system employs one or more artificial intelligence models trained with scenarios of users leaving the EGM because of too much loss, lack of interest in the game, and/or intoxication to determine that there is an increased chance that the user will soon terminate their gaming session and/or leave the gaming establishment.

If the system determines that the monitored aspects of the user's engagement do not result in an occurrence of a disengagement risk event, the system returns to block 102 of FIG. 1A and continues monitoring the user's engagement with the gaming establishment device. In these embodiments, if the tracked activities and/or events are not associated with an elevated risk of disengagement (i.e., the system assigns a risk below a threshold risk that triggers additional action), the system continues with the tracking of one or more events and/or activities that may potentially be indicative of the user's decision to continue (or discontinue) their gaming establishment device engagement. In other words, if the system determines that one or more tracked activities and/or events of the user's experience are not representative of an increased risk that the user will prematurely disengage from interacting with the gaming establishment device, the system continues with monitoring the user's engagement without initiating any intervention actions to potentially change the course of the user's engagement.

On the other hand, if the system determines that one or more of the monitored aspects of the user's engagement result in an occurrence of a disengagement risk event, the system determines an intervention action as indicated in block 106. In certain such embodiments, if the system determines that the tracked activities and/or events are associated with an elevated risk of disengagement (i.e., the system assigns a risk at or above a threshold risk that triggers additional action), the system determines, based on the parameters of the disengagement risk event that occurred, one or more actions to mitigate such a risk (or otherwise modify a potentially negative gaming establishment device engagement experience to a positive gaming establishment device engagement experience). Put differently, if the system determines that one or more tracked activities and/or events of the user's experience are representative of an increased risk that the user will prematurely disengage the gaming establishment device, the system determines zero, one or more actions to undertake to potentially change the course of the user's engagement. In these embodiments, since different users (or the same user) may find themselves in different situations based on the unique aspects of their individual engagement with the gaming establishment device (and/or the unique aspects of the user themselves), the system tailors the determined intervention action to the user's individual engagement with the gaming establishment device and/or the user themselves.

Following the determination of an intervention action, the system delivers the intervention action as indicated in block 108 of FIG. 1A. In certain embodiments, the system delivers the intervention action via the gaming establishment device (e.g., the system communicates an instruction to an EGM to increase a credit meter of the EGM responsive to the user at the EGM agreeing to continue with their gaming session for at least a set amount of time). In certain embodiments, the system delivers the intervention action via another gaming establishment device (e.g., the system communicates an instruction to another EGM to make itself unavailable until a specific user arrives). In certain embodiments, the system delivers the intervention action independent of any gaming establishment device. In certain embodiments, the system delivers the intervention action via employing the assistance of gaming establishment personnel (i.e., via communicating with one or more servers of a gaming establishment personnel management system which then issues one or more directives to gaming establishment personnel to deliver the intervention action). In certain embodiments, the system delivers the intervention action via employing the assistance of another user. In certain embodiments, the system delivers the intervention action via one or more gaming establishment management systems.

In certain embodiments, the system employs historical data of the user to determine the intervention action to be employed. In such embodiments, the system maintains information on a user's previous activity and utilizes that to determine one or more intervention actions to invoke. For example, the system maintains a database tracking 500 hours of a user's prior gaming sessions at one or more EGMs and the system ranks the amount of time the user spent with different game types (e.g., the system tracks that the user spent 450 hours playing poker games and 50 hours playing slot games) and/or ranks various attributes indicative of a positive (or negative) experience with these different games types. In this example, upon a determination that the tracked activities and/or events associated with user's play of a slots game are associated with a risk of disengagement greater than a threshold risk, the system modifies the operation of the EGM to switch to (or recommend) a poker game. In other examples, based on historical data of the user's prior interactions with one or more EGMs, if the system determines that the tracked activities and/or events are associated with a risk of disengagement greater than a threshold risk, the system switches to (or recommends a switch to) a progressive game, a game with a certain type of bonus (e.g., free spins vs a pick bonus), a new game or an older game the user previously enjoyed (as quantified by an extended gaming session and/or a lucrative gaming session). In certain embodiments, the system employs historical data of similar users to determine the intervention action to be employed. In such embodiments, the system maintains information on similar user's previous activities and utilizes that information to determine one or more intervention actions to invoke. In certain embodiments, the system employs historical data of all users to determine the intervention action to be employed. In such embodiments, the system maintains information on all user's (all identified users, all anonymous users and/or all users regardless of identification status) activities and utilizes that information to determine one or more intervention actions to invoke.

In certain embodiments, the system employs historical data associated with the gaming establishment device to determine the intervention action to be employed. In certain embodiments, the system employs historical data of similar gaming establishment devices (e.g., EGMs offering the same game, EGMs offering the type of game) to determine the intervention action to be employed. In certain embodiments, the system employs historical data of all gaming establishment devices to determine the intervention action to be employed.

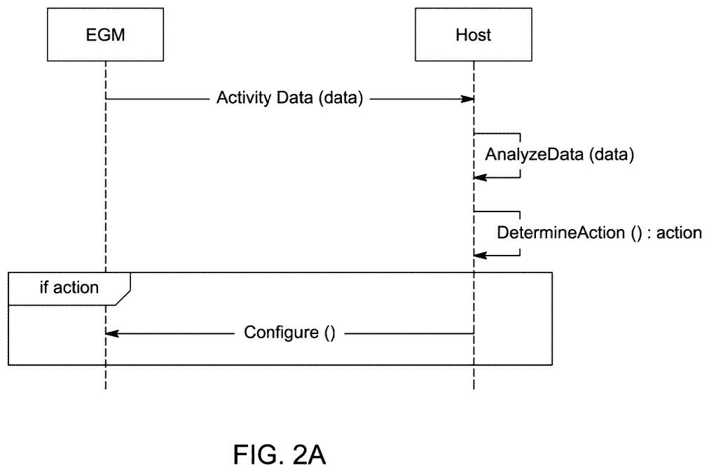

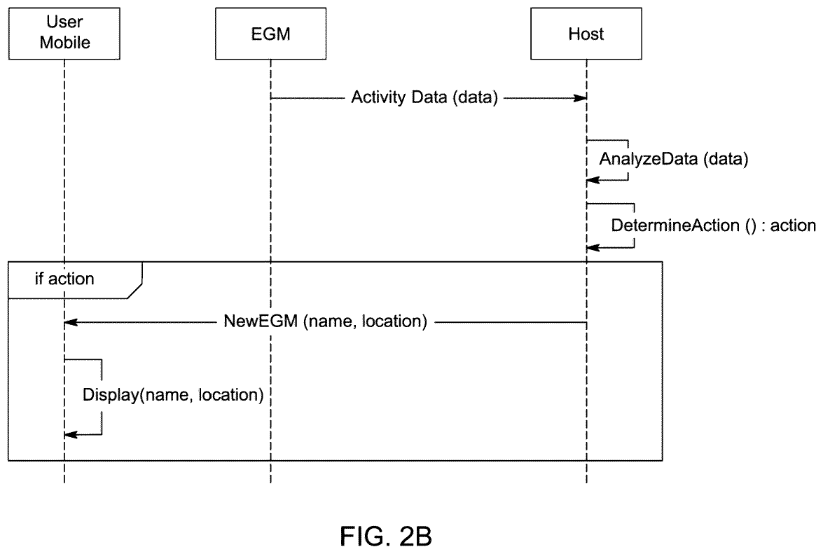

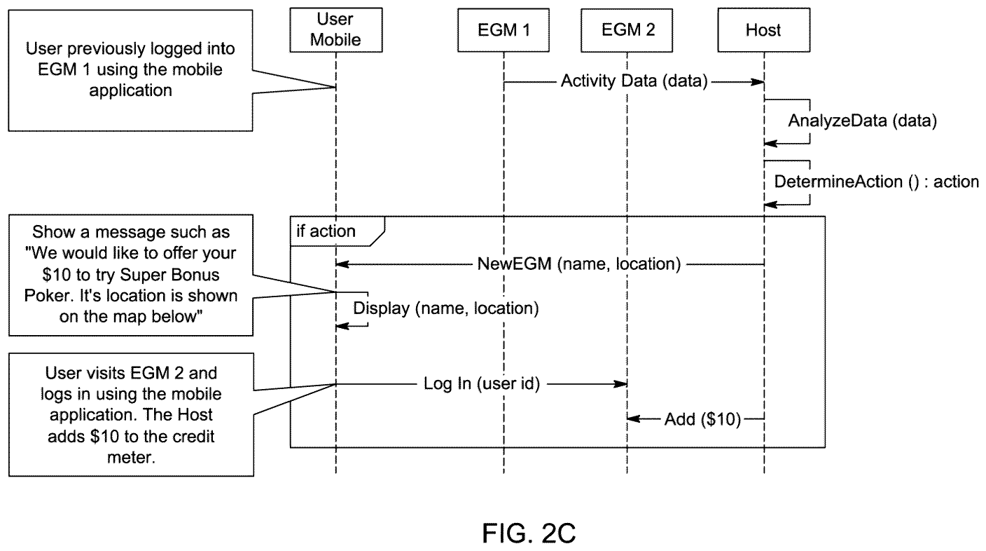

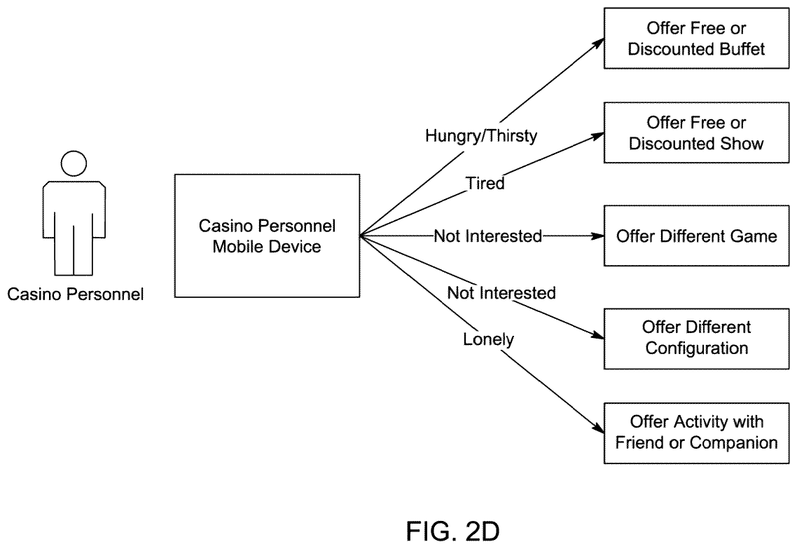

In certain embodiments, the intervention action determined by the system includes an operational change of the gaming establishment device. In certain such embodiments, to incentivize a user to continue to engage with a gaming establishment device and thus mitigate the risk of disengagement, the system determines an operational change to one or more gaming establishment devices and executes (or recommends an execution of) such a change. In these embodiments, the system and the gaming establishment device operate individually or collectively to determine if any intervention action is warranted and if so, one or more operational changes to the gaming establishment device with an aim towards reducing the risk of disengagement of the user from the gaming establishment device. For example, as seen in FIG. 2A (which illustrates the described interactions between a gaming establishment device (i.e., an EGM) and a component of the user engagement retention system (i.e., a host)), following the host receiving and analyzing activity data from the EGM, if warranted, the host determines an action associated with changing the configuration of the EGM and operates with the EGM to cause such an action to be undertaken.

In certain embodiments in which the gaming establishment device is an EGM, such an operational change of the EGM includes changing one or more parameters of the EGM, such as, but not limited to, changing a setting of one or more peripheral devices of the EGM (e.g., changing which display device is used by the EGM and/or changing a lighting brightness of the EGM), changing a game speed, changing a game volume, changing one or more graphics displayed by the EGM, and/or changing one or more sounds produced by the EGM. In certain such embodiments, the system uses one or more artificial intelligence models to generate new content for the user without changing operational aspects of the game itself. In these embodiments, the system obtains information about the user's gaming activity and/or the user's social media activity to build an artificial intelligence prompt to create new content for the user. For example, the system is aware that Player A likes sports because Player A posts about sports on social media. In this example, when the system detects Player A is at an increased risk for disengagement, the system uses a generative artificial intelligence host, such as one or more text-to-image models, to generate new sports theme content for Player A (e.g., sports content customized for the sports teams and/or participants that Player A is a fan of or dislikes).

In certain such embodiments in which the gaming establishment device is an EGM, such an operational change includes changing the game (e.g., changing from one slot theme to another slot theme) or changing the game type (e.g., changing from a slot game to a poker game). In different embodiments, the game or game theme the EGM is changed to includes, but is not limited to: any suitable slot game; any suitable wheel game; any suitable card game (including any suitable type of poker game, such as, but not limited to, a multiple hand poker game, Texas Hold'em, Omaha, Three Card Poker, Four Card Poker, Seven Card Stud, Pai Gow Poker, Caribbean Stud Poker, or Let It Ride Poker, as well as other suitable non-poker interactive cards games, such as, but not limited to, blackjack, Baccarat, Spanish 21, Casino War, Super Fun 21, or Vegas Three Card Rummy), any suitable offer and acceptance game; any suitable award ladder game; any suitable puzzle-type game; any suitable persistence game; any suitable selection game; any suitable cascading symbols game; any suitable ways to win game; any suitable scatter pay game; any suitable coin-pusher game; any suitable elimination game; any suitable stacked wilds game; any suitable trail game; any suitable bingo game; any suitable video scratch-off game; any suitable pick-until-complete game; any suitable shooting simulation game; any suitable racing game; any suitable promotional game; any suitable high-low game; any suitable lottery game; any suitable number selection game; any suitable dice game; any suitable skill game; any suitable auction game; any suitable reverse-auction game; any suitable group game; any suitable game in a service window of an EGM; any suitable game on a mobile device; and/or any suitable game of the present disclosure.

In certain other embodiments in which the gaming establishment device is an EGM, such an operational change includes changing a configuration of one or more games available at the EGM (e.g., changing the available denomination, activating one or more game features or deactivating one or more game features). In different embodiments, the activated/deactivated game features include, but are not limited to: a feature which superimposed one or more symbols over the displayed symbols; a feature which replaces one or more displayed symbols with a predetermined symbol pattern; a feature which replaces one or more displayed symbols with a predetermined pattern of wild symbols; a modifier feature (e.g., a multiplier feature); a wild symbol feature (e.g., a book-end wild symbols feature, a stacked wild symbols feature, an expanding wild symbols feature, and/or a nudging wild symbols feature); a feature modifying a quantity of wild symbols available to be generated; a retrigger symbol feature; an anti-terminator symbol feature; a reel feature (e.g., a locking reel feature, an expanding reel feature); a locking symbol position feature; a feature modifying a placed wager amount; a feature modifying a placed side wager amount; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying a paytable utilized for a play of a game; a feature modifying an average expected payback percentage of a play of a game; a feature modifying an average expected payout of a play of a game; a feature modifying one or more awards available; a feature modifying a range of awards available; a feature modifying a type of awards available; a feature modifying one or more progressive awards; a feature modifying which progressive awards are available to be won; a feature modifying one or more modifiers, such as multipliers, available; a feature modifying an activation of a reel (or a designated reel); a feature modifying an activation of a plurality of reels; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying an amount of free spins provided; a feature modifying a game terminating or ending bonus event condition; a feature modifying how one or more aspects of one or more games (e.g., colors, speeds, sound) are displayed; and/or a feature modifying any game play feature associated with any play of any game of the present disclosure.

In certain embodiments, the system determines the intervention action associated with an operational change of the gaming establishment device and automatically operates with the gaming establishment device to cause such an operational change to occur. In certain embodiments, the system determines that an intervention action is warranted and operates with the gaming establishment device to cause the gaming establishment device to determine an operational change and automatically cause such an operational change to occur. In these embodiments, the operational change occurs independent of any user inputs.

In certain embodiments, the system determines the intervention action associated with an operational change of the gaming establishment device and displays one or more messages to the user of the gaming establishment device recommending the operational change and enabling the user to cause or authorize the operational change to occur. In certain embodiments, the system determines that an intervention action is warranted and operates with the gaming establishment device to cause the gaming establishment device to determine an operational change and display one or more messages to the user of the gaming establishment device recommending the operational change and enabling the user to cause or authorize the operational change to occur. In these embodiments, the operational change occurs responsive to one or more user inputs, such as based on certain regulatory requirements that require a user to accept a change in the configuration of the EGM before the change can be applied.

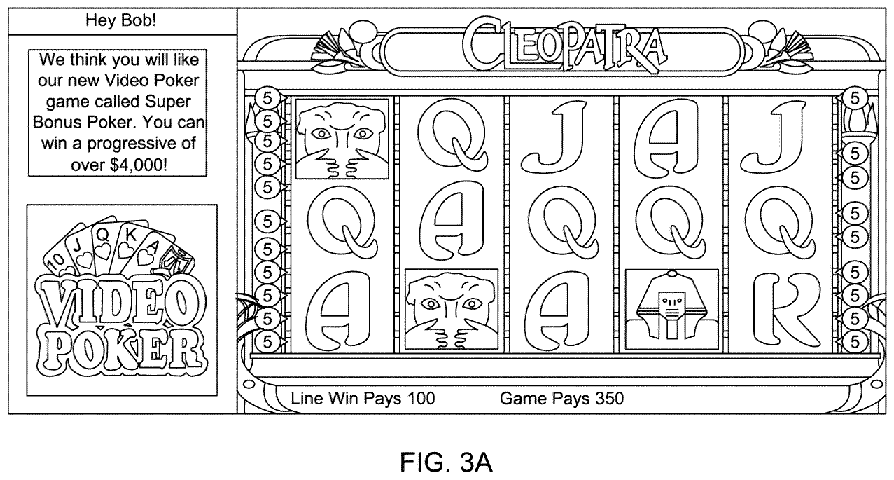

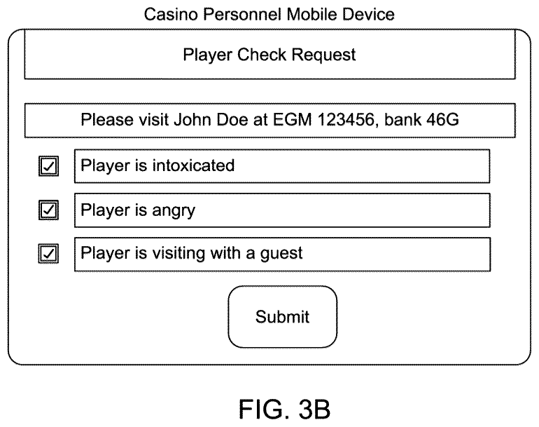

In certain embodiments, the system utilizes an externally controlled interface, such as a service window displayed by an EGM or by a display device associated with a component of a gaming establishment patron management system (e.g., a SMIB), to display information about certain operational changes the system recommends. For example, as seen in FIG. 3A, the system causes the EGM (or the SMIB) to display a service window recommending that a user of the EGM switches from a slot game to a video poker game. In certain embodiments, the system utilizes an externally controlled interface, such as a service window displayed by an EGM or by a display device associated with a component of a gaming establishment patron management system (e.g., a SMIB), to display an operational change the system recommends and enable the user to accept or reject the operational change. In certain embodiments, the system utilizes one or more electronic messages (e.g., text/SMS message, an e-mail and/or a notification to a mobile application being executed by a mobile device) to display information about certain operational changes the system recommends.

In certain embodiments, the determined intervention action is readily available to be undertaken at the gaming establishment device where the user is. For example, if the intervention action includes changing to a new game of the EGM, then prior to the change (or concurrent with the recommendation of the change) the EGM downloads or otherwise installs software associated with the new game. Such an embodiment provides that when the intervention action occurs, the user has a seamless experience without further contributing to a potential negative experience associated with the risk of disengagement.

In certain embodiments, the determined intervention action is not readily available to be undertaken at the gaming establishment device where the user is. In these embodiments, the system invokes the intervention action by employing another gaming establishment device (and potentially further causing an operational change to occur at that other gaming establishment device if needed) and instructs the user to visit the other gaming establishment device to effectuate the intervention action. For example, the system recommends a new game theme but then, given the limitations of the EGM where the user currently is at, must instruct the user how to visit another EGM with that game theme. In certain such embodiments, the system operates with a mobile device to inform the user of the location of the new EGM. For example, as seen in FIG. 2B (which illustrates the described interactions between a gaming establishment device (i.e., an EGM), a component of the user engagement retention system (i.e., a host) and a mobile device), following the host receiving and analyzing activity data from the EGM, if warranted, the host determines an action associated with moving to another EGM and operates with the user's mobile device to instruct the user to the location of that other EGM.

In certain embodiments, the intervention action determined by the system includes the system providing a benefit to the user. In certain such embodiments, to incentivize a user to continue to engage with a gaming establishment device and thus mitigate the risk of disengagement, the system determines a benefit and provides a benefit to the user. In these embodiments, the system and the gaming establishment device operate individually or collectively to determine if any intervention action is warranted and if so, one or more benefits for the user (and/or an associate of the user) with an aim towards reducing the risk of disengagement of the user from the gaming establishment device. In certain such embodiments, the benefit includes a static value (or a variable value determined in accordance with one or more random determinations), such as an amount funds transferred to a gaming establishment account of the user (e.g., funds transferred to a cashless wagering account of a user via a slot accounting system (“SAS”) AFT/EFT transfer protocol and/or a game-to-system (“G2S) transfer protocol employing zero, one or more calls to zero, one or more application programming interfaces, such as a representational state transfer application programming interface or an application programming interface over a message bus, associated with the system that maintains the gaming establishment account of the user), an amount of funds associated with a cashless ticket voucher, an amount of credits transferred to a credit balance of the gaming establishment device, a quantity of player tracking points, a player tracking point modifier applicable to a quantity of player tracking points subsequently earned by the user, a player tracking point modifier applicable to a quantity of player tracking points previously earned by the user, a quantity of non-cashable promotional credits usable to fund one or more plays of one or more games of chance, and/or a quantity of virtual credits usable for a play of a social or non-wagering game.

In certain embodiments, the determined benefit is based on the amount of funds involved in one or more transactions with the gaming establishment device. In one such embodiment, the determined benefit is a percentage of the amount of funds wagered during one or more wagering sessions at one or more EGMs. In another such embodiment, the determined benefit is a percentage of the amount of funds wagered during one or more wagering sessions at one or more EGMs selected from a predetermined range of percentages, such as 1% to 2%. In another such embodiment, the determined benefit is an amount selected based on the amount of funds wagered during one or more wagering sessions at one or more EGMs. In another such embodiment, the determined benefit is a percentage of the amount of funds lost (or won) during one or more wagering sessions at one or more EGMs. In another such embodiment, the determined benefit is a percentage of the amount of funds lost (or won) during one or more wagering sessions at one or more EGMs selected from a predetermined range of percentages, such as 1% to 2%. In another such embodiment, the determined benefit is an amount selected based on the amount of funds lost (or won) during one or more wagering sessions at one or more EGMs.

In certain embodiments, the determined benefit is based on an identity of the user of the gaming establishment device. In one such embodiment, the determined benefit is based on a status, such as a player tracking status, of the user of the gaming establishment device. In another such embodiment, the determined benefit is based on the presence (or lack thereof) of one or more accounts, such as cashless wagering accounts, sporting event wagering accounts and/or gaming establishment retail accounts, associated with the user of the gaming establishment device.

In certain embodiments, the determined benefit is based on the circumstances of the determination of the disengagement risk event. In one such embodiment, the determined benefit is based on when the disengagement risk event occurred relative to how long the user was engaging with the gaming establishment device. In another such embodiment, the determined benefit is based on a location of the gaming establishment device where the disengagement risk event occurred (e.g., a disengagement risk event occurring in association with an EGM in a high roller room of a casino is associated with a different benefit than a similar occurrence of the disengagement risk event occurring in association with an EGM elsewhere).

In certain embodiments, the intervention action determined by the system includes the system providing a benefit to the user in association with instructing the user to switch to a different gaming establishment device. In certain such embodiments, to incentivize a user to continue to engage with the gaming establishment and thus mitigate the risk of disengagement, the system determines another gaming establishment device and offers the user a benefit to continue with their gaming experience at the other gaming establishment device. In these embodiments, the system and the gaming establishment devices operate individually or collectively to determine if any intervention action is warranted and if so, one or more benefits for the user (and/or an associate of the user) with an aim towards reducing the risk of disengagement of the user from the gaming establishment. For example, as seen in FIG. 2C (which illustrates the described interactions between two gaming establishment devices (i.e., EGM1 and EGM2), a component of the user engagement retention system (i.e., a host) and a mobile device), following the host receiving and analyzing activity data from EGM1, if warranted, the host determines an action associated with moving to EGM2 and providing the user $10 at EGM2 and operates with the user's mobile device to instruct the user to the location of EGM2 within a set amount of time from the offer to retrieve the $10.

In certain embodiments, the intervention action determined by the system includes the system offering the user a benefit to take a break from engaging with the gaming establishment device by undertaking another activity associated with the gaming establishment. For example, if the system determines that a user at an EGM is exhausted and needs to take a break, then with a goal of having the user take a break without leaving the gaming establishment, the system offers the user free (or discounted) activities at a bar, night club, spa, pool, show or other experience associated with the gaming establishment property. In certain such embodiments, the benefit additional includes offering the other activity associated with the gaming establishment with an additional reward offer (e.g., money, physical prizes, comps, loyalty points, virtual credits and/or free play) for returning to the gaming establishment device. Continuing with the above example, following the system determining that the user at the EGM is exhausted and needs to take a break, the system offers the user one or more tickets to a free show and $25 if they return to the EGM (or a similar EGM) after the show to initiate another wagering session.

In certain embodiments, the intervention action determined by the system includes the system offering the user a benefit to take a break from engaging with the gaming establishment device by undertaking another activity independent of the gaming establishment. In these embodiments, if the system determines that a user is associated with an increased risk of disengagement, the system offers the user an incentive to cease their current engagement and return to the gaming establishment at a later point in time. For example, if the system determines that a user at an EGM is exhausted and needs to take a break, the system offers the user an incentive to cease wagering for the time being and return the next week for an amount of funds then deposited in a gaming establishment account associated with the user.

In certain embodiments, the system determines the benefit for the user of the gaming establishment device determined to be at a risk of disengagement from the gaming establishment device (and/or the gaming establishment in general). In certain embodiments, the system additionally or alternatively determines the benefit for another user if the user of the gaming establishment device is determined to be at a risk of disengagement from the gaming establishment device (and/or the gaming establishment in general). In these embodiments, if the system determines that one way to mitigate a risk of a user at a gaming establishment device from disengaging is to provide (or offer to provide) a benefit to a different user, such as a user related to the user at the gaming establishment device, the system proceeds with providing (or offering to provide) such a benefit to another user. For example, if the system determines that a user is at an elevated risk of disengagement because the system determines that the user is lonely, the system utilizes traveling party information associated with the user (e.g., an identity of a companion, spouse or significant other) to determine one or more benefits (e.g., tickets to a show, club or buffet for the user and a guest) that encourage the user at the gaming establishment device to interact with someone from their traveling party to counteract such determined loneliness. In this example, the system obtains such traveling party information from the user, from a gaming establishment patron management system, from gaming establishment personnel interacting with the gaming establishment patron management system and/or from a hotel reservation system in communication with the system. In certain cases, the system offers a benefit to the member of the traveling party to aid in mitigating the risk of another user disengaging (e.g., if Player A is lonely and traveling with Player B, the system notifies Player B, via a mobile application, that Player B can receive $25 in free play if they gamble at the EGM next to Player A). In certain cases, the system additionally or alternatively offers a benefit to the user at the gaming establishment device conditional upon one or more actions of another user (e.g., if Player A is lonely and traveling with Player B, the system notifies Player A that Player A can receive $25 in free play if they gamble at the EGM next to Player B). In these cases, Player A may travel to Player B or Player B may travel to Player A or Players A and B may go to two EGMs next to each other such that when the system detects that Player A and Player B are at two adjacent EGMs (based on a database of EGM location and via operating with the gaming establishment patron management system to locate which EGM each player is logged into), the system transfers $25 to Player A and/or Player B.

In certain embodiments, the intervention action determined by the system includes gaming establishment personnel intervention. In certain such embodiments, the system communicates with one or more servers of a gaming establishment personnel management system which then dispatches one or more members of gaming establishment personnel to the gaming establishment device to interact with the user. In certain instances, the intervention action includes gaming establishment personnel engaging with the user of the gaming establishment device. In certain instances, the intervention action additionally or alternatively includes gaming establishment personnel providing (or offering to provide) one or more benefits to the user (and/or another user), such as gaming establishment personnel offering a coupon for a free coffee to a player at an EGM determined by the system to be tired.

In certain embodiments, since certain parameters that factor into the user's emotional state cannot be deduced by the system and/or an artificial intelligence model (i.e., the system determines an increased risk of disengagement without pinpointing the exact cause), as seen in FIG. 1B, in addition to monitoring a user's engagement with a gaming establishment device and determining whether zero, one or more monitored aspects of the user's engagement result in an occurrence of a disengagement risk event (as described above and indicated by blocks 202 and 204), the system dispatches one or more members of gaming establishment personnel to the gaming establishment device to interact with the user to assess the situation as indicated in block 206. In certain such embodiments, the system operates with one or more servers of a gaming establishment personnel management system which then issues one or more directives to gaming establishment personnel to interact with the user.

In these embodiments, as seen in FIG. 1B, following the assessment by gaming establishment personnel, the system and the dispatched member of gaming establishment personnel interact to provide the system additional information regarding the assessed situation as indicated in block 208. In certain embodiments, the system operates directly with gaming establishment personnel via receiving the additional information regarding the assessed situation from one or more computing components associated with gaming establishment personnel. For example, as seen in FIG. 3B, following the dispatch of gaming establishment personnel to an EGM being played by a user exhibiting an increased risk of disengagement, the member of gaming establishment personnel interface with the system via a mobile device application on a mobile device to gather additional information regarding the user, such as whether the user is exhibiting any signs of different potential emotional states (e.g., being happy, angry, tired, frustrated), and/or entering a numerical rating of different potential emotional states (e.g., enter a rating how tired the user is from 1 to 10). In certain embodiments, the system operates indirectly with gaming establishment personnel via receiving from one or more servers of a gaming establishment personnel management system the additional information regarding the assessed situation which such servers receive from one or more computing components associated with gaming establishment personnel.

In certain embodiments, based on the additional information gathered by the member of gaming establishment personnel, if applicable, the system takes one or more actions to remedy the situation assessed by the member of gaming establishment personnel. That is, the system determines an intervention action and operates to deliver the determined intervention action (as described above and indicated by blocks 210 and 212). In such embodiments, the system utilizes both objective observations made by the system (that may be indicative of the user at the gaming establishment being at an increased risk of disengagement) and subjective observations made by gaming establishment personnel (and, in certain instances, submitted by the user themselves) to determine zero, one or more corrective measures to alter how the user is currently interacting with the gaming establishment device.

It should be appreciated that different assessed situations by gaming establishment personnel result in different recommended courses of action which the system instructs gaming establishment personnel to proceed with in interacting with the user. For example, as seen in FIG. 2D, if the gaming establishment personnel notes the user looks lonely, the system offers the user an activity with their spouse, such as a discounted Spa or Show. In such embodiments, the system and gaming establishment personnel operate individually or collectively to recommend (and/or facilitate) one or more intervention actions including, but not limited to, moving the user to another location (e.g., if an employee sees the user does not like the area because it is too noisy or has too many people or other user's in the area do not match the user's demographics of age or status), offering the user food or beverages, offering the user a break from gaming, offering the user some companionship, offering the user a property service (e.g. a spa service, a gym service, entertainment, a bar service), offering the user a different game theme, offering the user a different game type and/or offering the user a different game configuration.

In certain embodiments, in addition to interacting with the system to provide additional information that the system employs to quantify if the user is at an increased risk for disengagement and/or any intervention action to undertake to mitigate the increased risk, the system enables gaming establishment personnel to enter any suggested corrective action (e.g., suggest that the user play another theme or be offered free food). Such suggestions enable the system to leverage the experience and instincts of gaming establishment personnel. For example, an employee might have watched a player play uninterrupted for hours and knows that the player probably needs to eat. In another example, an employee notifies the system that a user should go to a show in 30 minutes because the employee communicated with the user and learned that the user is tired and would like to see the show.

In certain embodiments in which the system employs the experience and instincts of gaming establishment personnel, if the gaming establishment personnel notifies the system that the user is not at a risk of disengagement, the system does not take or recommend any intervention action but rather continues to monitor as described above. In certain additional embodiments, if the gaming establishment personnel notifies the system that the user is at a risk of disengagement, the system enables the gaming establishment personnel to handle the situation without any subsequent system intervention. For example, if an employee learns that Player A is tired, the employee handles the situation without system intervention by giving Player A a coupon for a free coffee and pastry from the coffee shop.

In certain embodiments, the system dispatches one or more members of gaming establishment personnel to a gaming establishment device via one or more alerts communicated to a mobile device, such as a mobile workstation, of the members of gaming establishment personnel. In these embodiments, in addition to alerting the member of gaming establishment personnel about the increased risk of disengagement (and potentially the factors that resulted in the system making such a determination), the system informs the member of gaming establishment personnel additional information regarding the user (e.g., player tracking status, lifetime value to the gaming establishment) and/or the gaming establishment device (e.g., type of game being played, difference between actual wins during user's wagering session and theoretical wins during user's wagering session).

It should be appreciated that in certain embodiments, the user disengaged from the gaming establishment device prior to the system determining that the user was at a risk of disengagement or the determined intervention action did not change the user's course of action and the user disengaged from the gaming establishment device (and potentially left the gaming establishment in general). In these embodiments, in an effort to mitigate the effects of a potential negative experience, the system determines one or more post-disengagement actions and operates to undertake such post-disengagement actions. In such embodiments, following the system determining a user's experience at a gaming establishment device qualified as a risk of disengagement from the gaming establishment (i.e., the user may never coming back to the gaming establishment given their experience), the system determines one or more incentives in an attempt to eventually bring the user back to the gaming establishment. Such incentives include at least a timing parameter (i.e., when is the incentive applicable to be realized) and a benefit parameter (e.g., what type of benefit is offered of what value). In determining the benefit parameter and similar to the intervention action determined while the user is still engaging with the gaming establishment device, the post-disengagement action includes any suitable benefit determined to be of value to the user, such as, but not limited to, free (or discounted) hotel rooms, free (or discounted) show tickets, free (or discounted) travel to the gaming establishment, free (or discounted) restaurant or food & beverage coupons, free (or discounted) gaming establishment merchandise and/or retail shopping, a quantity of player tracking points, gaming establishment free play, and/or a deposit of an amount of cash (or a quantity of promotional credits) into a gaming establishment account associated with the user, such as a user's cashless wagering account. In determining the timeline parameter, the system may leverage historical activity of the user to determine offer timelines that are likely to work with this particular user (e.g., if a user always visits a gaming establishment on holidays, then the offer may be time restricted to the next holiday weekend). In certain embodiments, the system associates the benefit of the determined post-disengagement action with an account associated with the user and alerts the user of the association via text/SMS message, an e-mail and/or a notification to a mobile application being executed by a mobile device. In certain embodiments, the system employs a voucher to convey the benefit of the determined post-disengagement action and communicates the voucher to the user via text/SMS message, an e-mail and/or a notification to a mobile application being executed by a mobile device.

Accordingly, a configuration of undertaking (or offering to undertake) zero, one or more intervention actions responsive to a determination that a user at a gaming establishment device represents above a threshold risk of disengagement (from the gaming establishment device and/or the gaming establishment in general) represents an operational change to how gaming establishment systems operate for the betterment of both users (via a more positive (or less negative) gaming establishment experience) and gaming establishment operators (via combating certain factors that would diminish user's future engagement with the gaming establishment device). Such a configuration further enables different users to have different customizable interactions at a gaming establishment while automating and improving the efficacy of certain tasks (by reducing or eliminating gaming establishment personnel having to make, at best, educated guesses in trying to determine why certain users take/don't take certain actions). As such, gaming establishment operators are able to allocate user retention resources more efficiently and thus reduce wasted resources, such as wasted computational resources associated with offering users benefits that they have no interest in and/or at the wrong time and/or responsive to wrong behavioral triggers.

It should be appreciated that in different embodiments, one or more of: when to monitor a user's engagement with a gaming establishment device to determine a risk of disengagement, what aspects of a user's engagement with a gaming establishment device to monitor determine a risk of disengagement, which users to monitor how they interact with a gaming establishment device to determine a risk of disengagement, which intervention action to undertake if applicable, when to undertake a determined intervention action, whether to employ gaming establishment personnel in undertaking a determined intervention action, and/or any determination of the present disclosure is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the system, determined independent of a random determination at the system, determined based on at least one play of at least one game, determined independent of at least one play of at least one game, determined based on a user's selection, determined independent of a user's selection, determined based on one or more side wagers placed, determined independent of one or more side wagers placed, determined based on the user's primary game wager, determined independent of the user's primary game wager, determined based on time (such as the time of day), determined independent of time (such as the time of day), determined based on an amount of coin-in accumulated in one or more pools, determined independent of an amount of coin-in accumulated in one or more pools, determined based on a status of the user (i.e., a user tracking status), determined independent of a status of the user (i.e., a user tracking status), determined based on one or more other determinations of the present disclosure, determined independent of any other determination of the present disclosure or determined based on any other suitable method or criteria.

It should be appreciated that the above-described embodiments of the present disclosure may be implemented in accordance with or in conjunction with one or more of a variety of different types of systems, such as, but not limited to, those described below. That is, the present disclosure contemplates a variety of different systems each having one or more of a plurality of different features, attributes, or characteristics. A “system” as used herein refers to various configurations of: (a) one or more servers; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link.

In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, as indicated above, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling certain games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control such games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

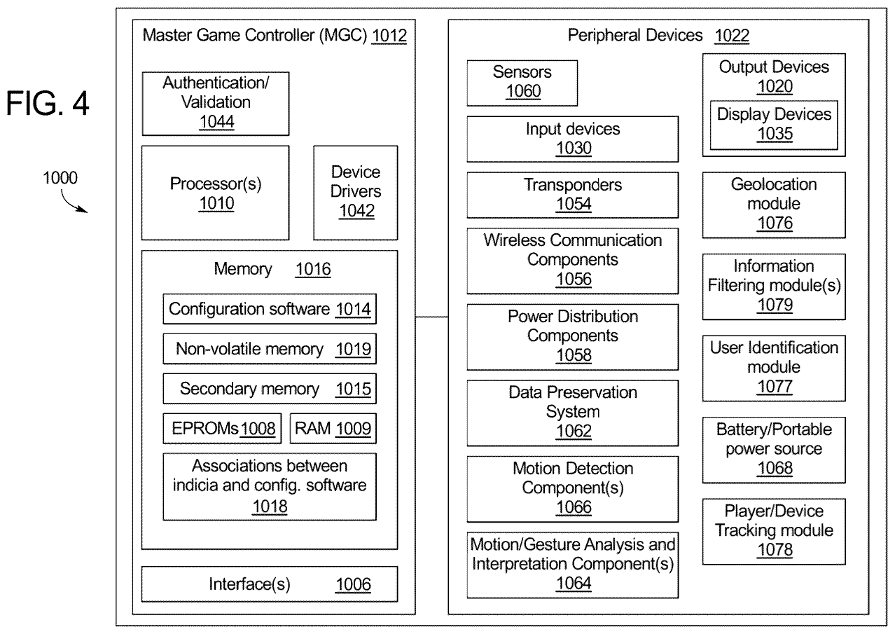

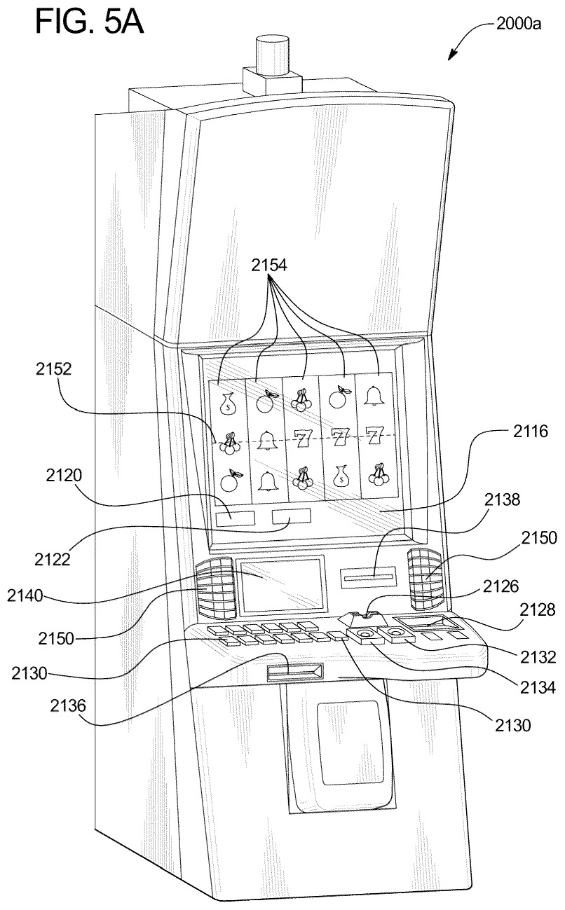

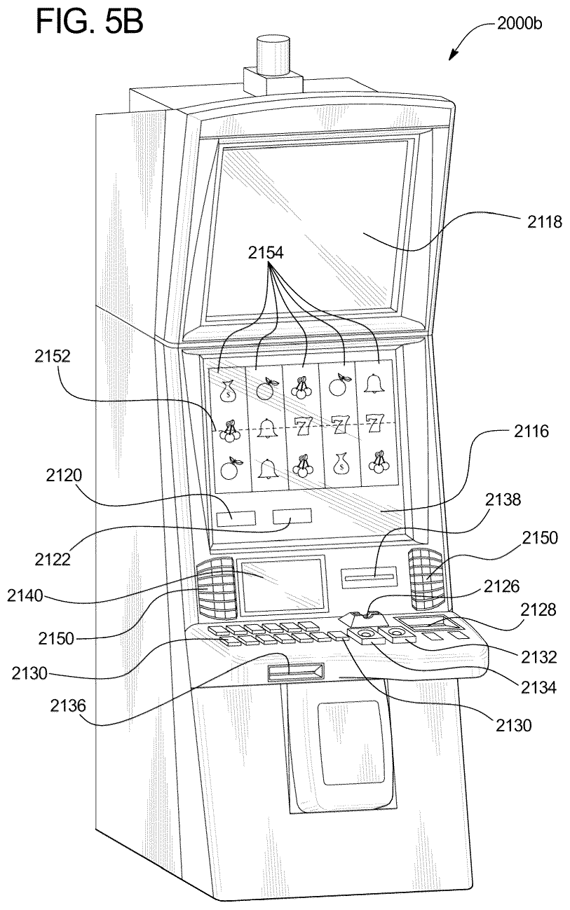

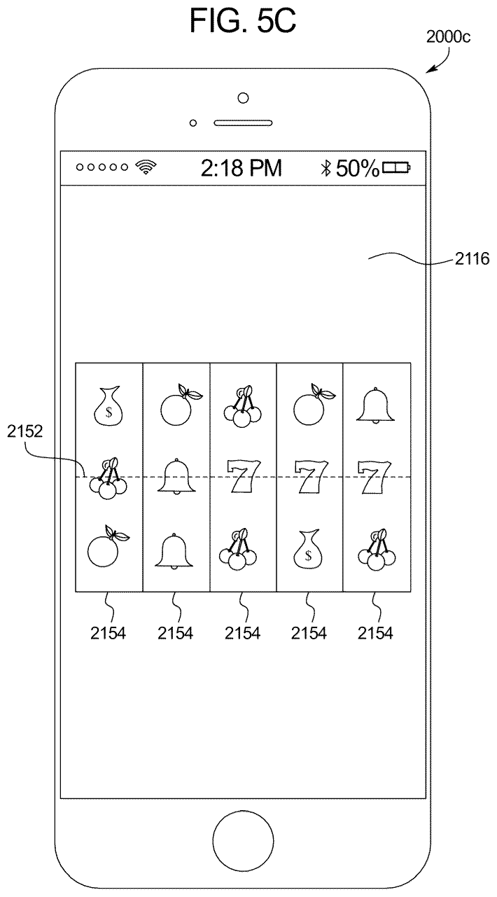

FIG. 4 is a block diagram of an example EGM 1000 and FIGS. 5A and 5B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 5C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. In various embodiments, the processes of the present disclosure are represented by a set of instructions stored in one or more memories and executed by one or more processors. Although the process is described with reference to certain of the flowcharts shown in certain of the figures, many other processes of performing the acts associated with this illustrated process may be employed. For example, the order of certain of the illustrated blocks or diamonds may be changed, certain of the illustrated blocks or diamonds may be optional, or certain of the illustrated blocks or diamonds may not be employed.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 5A includes a central display device 2116, a player tracking display 2140, a credit display 2120, and a bet display 2122. The example EGM 2000b illustrated in FIG. 5B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 5B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination (or in any other manners described above.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer or by initiating creation of a paper check that is mailed to the player.

In certain embodiments, the one or more servers include a payment server that handles establishing and cashing out players'account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purposes computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing device typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary, a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
track instances of an event occurring in association with a gaming establishment device,
responsive to the tracked instances of the event being associated with a first risk of disengagement exceeding a threshold risk of disengagement:
determine an operational change of the gaming establishment device, the determination being based on at least one of the event and the tracked instances of the event, and
deliver the determined operational change to the gaming establishment device, and
responsive to the tracked instances of the event being associated with a second risk of disengagement below the threshold risk of disengagement, continue to track instances of the event occurring in association with the gaming establishment device.

2. The system of claim 1, wherein the gaming establishment device comprises an electronic gaming machine.

3. The system of claim 2, wherein the tracked event comprises at least one of a wager placed, a frequency of wagers placed, a game played, a frequency of games played, an input received by the electronic gaming machine, an input made independent of the electronic gaming machine, a frequency of inputs received, an amount lost, and an amount of time elapsed engaging with the electronic gaming machine.

4. The system of claim 2, wherein the operational change of the electronic gaming machine comprises at least one of a change of a game available to be played, an activation of a first game feature, a deactivation of a second game feature, and a configuration change.

5. The system of claim 1, wherein the tracked event comprises an activity undertaken independent of the gaming establishment device.

6. The system of claim 1, wherein the operational change is associated with a determined benefit for at least one of a user engaging with the gaming establishment device and another user currently not engaging with the gaming establishment device.

7. The system of claim 1, wherein the delivery of the determined operational change to the gaming establishment device comprises communicating data that results in a display device displaying the operational change as a recommendation.

8. The system of claim 7, wherein the memory device stores a plurality of further instructions that when executed by the processor responsive to a receipt of data associated with an input to accept the recommendation, cause the processor to communicate data to the gaming establishment device to cause the operational change to occur.

9. The system of claim 1, wherein different users are associated with different threshold risks of disengagements.

10. A system comprising:
a processor; and
a memory device that stores a plurality of instructions that, when executed by the processor, cause the processor to:
track occurrences of each of a first activity associated with an engagement of a gaming establishment device and a second, different activity associated with the engagement of the gaming establishment device,
responsive to the tracked occurrences of the first activity being associated with at least a first risk of disengagement from the gaming establishment device:
determine a first operational change of the gaming establishment device, and
deliver the determined first operational change to the gaming establishment device, and
responsive to the tracked occurrences of the second, different activity being associated with at least a second, different risk of disengagement from the gaming establishment device:
determine a second, different operational change of the gaming establishment device, and
deliver the determined second, different operational change to the gaming establishment device.

11. The system of claim 10, wherein at least one of the first activity and the second, different activity comprises a lack of engagement with the gaming establishment device.

12. A method of operating a system, the method comprising:
tracking, by a processor, instances of an event occurring in association with a gaming establishment device,
responsive to the tracked instances of the event being associated with a first risk of disengagement exceeding a threshold risk of disengagement:
determining, by the processor, an operational change of the gaming establishment device, the determination being based on at least one of the event and the tracked instances of the event, and
delivering the determined operational change to the gaming establishment device, and
responsive to the tracked instances of the event being associated with a second risk of disengagement below the threshold risk of disengagement, continuing to track, by the processor, instances of the event occurring in association with the gaming establishment device.

13. The method of claim 12, wherein the gaming establishment device comprises an electronic gaming machine.

14. The method of claim 13, wherein the tracked event comprises at least one of a wager placed, a frequency of wagers placed, a game played, a frequency of games played, an input received by the electronic gaming machine, an input made independent of the electronic gaming machine, a frequency of inputs received, an amount lost, and an amount of time elapsed engaging with the electronic gaming machine.

15. The method of claim 13, wherein the operational change of the electronic gaming machine comprises at least one of a change of a game available to be played, an activation of a first game feature, a deactivation of a second game feature, and a configuration change.

16. The method of claim 12, wherein the tracked event comprises an activity undertaken independent of the gaming establishment device.

17. The method of claim 12, wherein the operational change is associated with a determined benefit for at least one of a user engaging with the gaming establishment device and another user currently not engaging with the gaming establishment device.

18. The method of claim 12, wherein the delivery of the determined operational change to the gaming establishment device comprises communicating data that results in a display device displaying the operational change as a recommendation.

19. The method of claim 18, further comprising, responsive to a receipt of data associated with an input to accept the recommendation, communicating data to the gaming establishment device to cause the operational change to occur.

20. The method of claim 12, wherein different users are associated with different threshold risks of disengagements.
